(19) United States
(12) Patent Application Publication
(10) Pub. No.: US 2009/0055746 A1
(43) Pub. Date: Feb. 26, 2009

(54) MULTIMEDIA PRESENTATION CREATION

(75) Inventors: Nevenka Dimitrova, Bangalore (IN); Mauro Barbieri, Eindhoven (NL); Lalitha Agnihotri, Fishkill, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,092

(22) PCT Filed: Jan. 17, 2006
(86) PCT No.: PCT/IB2006/050171

§ 371 Date: Jun. 3, 2008

(30) Foreign Application Priority Data
Jan. 20, 2005 (EP) 05100339.0

(51) Int. Cl. G06F 3/048

(52) U.S. Cl. 715/731

(57) ABSTRACT

The present invention enables combining personal media content and additional content with the purpose of generating a more appealing and engaging experience to the user when being presented the personal media content. The invention therefore relates to a method and a device for generating a multimedia presentation, comprising obtaining a user selection of a first media file (step 202), obtaining a user selection of a media file source (step 208), matching content associated data of the first media file, with content associated data of at least one second media file from the media file source (step 214), generating at least one user inquiry related to the content associated data of at least the first media file (step 216), and creating the multimedia presentation, based on the first media file and the at least one second media file, said multimedia presentation comprising the at least one generated user inquiry (step 218).

The present invention refers to generating a multimedia presentation from personal content.

The recent trend in consumer electronics, to include still and moving picture cameras in a variety of appliances has had the effect that users increasingly collect huge amounts of photos and videos. Showing the acquired photo collections to friends and relatives in multimedia presentations such as photo slide shows has become common. In line with this development digital presentation composition functionalities are already a must-have in many consumer electronic devices, such as TV sets, set-top boxes, etc. Photos from a vacation sometimes become boring to watch, especially if the pictures do not contain sufficient information about where they were taken, when the vacation was, who participated and why it all happened, to mention a few questions only. Watching old pictures can be especially boring as the participants tend to remember at most a fraction of the relevant and interesting information.

One way to avoid losing information would be to annotate the pictures, such that for instance the pictures could be presented together with the pertinent information. Indeed, many users would like to enrich their presentations, by for instance generating vacation photo slideshows. Generating such slideshows requires various skills and the time required with today's tools is prohibitive.

As many sources of multimedia content are nowadays available to most consumers, for example the Internet, DVD collections, cable TV, finding suitable multimedia content with which the private material may be enriched is a huge task, given the current searching technology.

Manual editing of a multimedia presentation, however, is extremely cumbersome and time consuming.

The patent document U.S. Pat. No. 6,211,974 B1 by Haneda discloses a photo laboratory system and method for recording a photo slideshow which combines a user's photos with additional content, such as audio, video, to enhance the photo slideshow.

The system by Haneda is photo laboratory system and is not designed to be used for altering slideshows being presented.

There is therefore a need for a technique to enable generating an interactive slideshow and to enable presenting the interactive slideshow to the user.

The invention is defined by the independent claims. The dependant claims define advantageous embodiments of the invention

The invention relates in general to providing an interactive non-linear multimedia presentation.

The present invention enables combining personal media content and additional content with the purpose of generating a more appealing and engaging experience to the user when being presented the personal media content.

One object of the present invention is to provide a method for generating in real time an interactive multimedia presentation.

According to a first aspect of the present invention, this object is achieved by a method for generating a multimedia presentation, comprising the steps of obtaining a user selection of a first media file, obtaining a user selection of a media file source, matching content associated data of the first media file, with content associated data of at least one second media file from the media file source, generating at least one user inquiry related to the content associated data of at least the first media file, and creating the multimedia presentation, based on the first media file and the at least one second media file, said multimedia presentation comprising the at least one generated user inquiry, such that a user may receive a more appealing and engaging experience when being presented the multimedia presentation.

Another object of the invention is to provide a device for generating in real time an interactive multimedia presentation.

According to a second aspect of the present invention, this object is achieved by a multimedia presentation generating device, for generating a multimedia presentation, said device comprising a user input interface, arranged to obtain input from a user, a matching unit, arranged to match content associated data of a first media file with content associated data of at least one second media file, a user inquiry generating unit, arranged to generate at least one user inquiry related to content associated data of a media file, a multimedia presentation creating unit, connected to the matching unit and the user inquiry generating unit, wherein the multimedia generating unit is arranged to create a multimedia presentation based on the first media file, the at least one second media file, and the content associated data of at least the first media file, a control unit, connected to the user input interface, the matching unit, the multimedia presentation creating unit, and the user inquiry generating unit, which control unit is arranged to control the steps of obtaining a user selection of a first media file, obtaining a user selection of a media file source, matching content associated data of the first media file with content associated data of at least one second media file from the media file source, generating at least one user inquiry related to the content associated data of at least the first media file, and creating the multimedia presentation, based on the first media file and the at least one second media file, said multimedia presentation comprising the at least one generated user inquiry, such that a user may receive a more appealing and engaging experience when being presented with the multimedia presentation.

Still another object of the present invention is to provide a computer program product for generating in real time an interactive multimedia presentation.

According to a third aspect of the present invention, this object is achieved by a computer program product comprising a computer readable medium, having thereon computer program code means, to make a multimedia presentation generating device or a computer execute, when said computer program code means is loaded in the multimedia presentation generating device or the computer, obtaining a user selection of a first media file, obtaining a user selection of a media file source, matching content associated data of the first media file with content associated data of at least one second media file from the media file source, generating of at least one user inquiry related to the content associated data of at least the first media file, and creating of the multimedia presentation, based on the first media file and the at least one second media file, said multimedia presentation comprising the at least one generated user inquiry, such that a user may receive a more appealing and engaging experience when being presented the multimedia presentation.

Yet another object of the present invention is to provide a computer program element for generating in real time an interactive multimedia presentation.

According to a third aspect of the present invention, this object is achieved by a computer program element comprising computer program code means, to make a multimedia presentation generating device or a computer execute, when said computer program code means is loaded in the multimedia presentation generating device or the computer, obtaining a user selection of a first media file, obtaining a user selection of a media file source, matching content associated data of the first media file with content associated data of at least one second media file from the media file source, generating of at least one user inquiry related to the content associated data of at least the first media file, and creating of the multimedia presentation, based on the first media file and the at least one second media file, said multimedia presentation comprising the at least one generated user inquiry, such that a user may receive a more appealing and engaging experience when being presented the multimedia presentation.

The present invention has the following advantages:

The present invention has the advantage that it enables the user to interactively create a multimedia presentation, such that the user may receive a more appealing and engaging experience when being presented the multimedia presentation.

Further advantages are that the present invention simplifies enormously authoring interactive presentations so that users with little computer skills can come up with great interactive presentations. Furthermore, it provides saving considerable amount of time by giving choices and associating the media and information on behalf of the user. It provides allowing users to create automatically an interactive presentation that is creative, being based on the inquiries. Moreover it provides allowing reuse and repurposing of multimedia content, which multimedia content otherwise would have been kept aside. It may moreover open up an opportunity to providers of multimedia content to sell prepackaged content for interactive presentations.

Claim 2 is directed to presenting user inquiries, receiving user input related to the inquiry and updating the presentation in dependence of the received input.

This claim has the advantage of providing user inquiries, on which answers to the multimedia presentation are dependent.

Claim 3 is directed towards obtaining content associated data of the first media file.

This claim is advantageous since this content associated data may be used in the step of matching.

Claim 4 is directed to obtaining media file property related data.

This brings the advantage that colour compositions, textures, shapes, motion, audio features, etc. may be obtained.

Claim 5 is directed to applying a filtering criterion.

This is an advantage since the number of matching second media files may become too large without using a filtering criterion.

Claim 6 is directed to receiving content associated data from the user.

This is also an advantage since the available content association may need to be enriched.

Claim 7 is directed to matching content association data.

This is advantageous since the content associated data as received from the user is used in the step of matching content associated data.

Claim 8 is directed to generating at least one user inquiry related to content associated data as received from the user.

This is also an advantage since the user can influence the user inquiries and therefore the multimedia presentation.

Claims 9 and 10 are directed to receiving content associated data comprising meta data and annotation data, respectively, from the user.

The advantage is that the user can input data which easily can be used in the multimedia presentation.

Claims 12 and 13 are directed to the possibility to connect a multimedia presentation generating device to external multimedia presentation units and media file location units, respectively.

It is indeed an advantage to show a presentation on an external presentation unit. Also, it may also be a huge advantage to search for information within external servers, such as accessible servers being connected to the Internet.

The gist of the present invention is to hence utilise user input as control data for generating a multimedia presentation in real time.

These and other aspects of the invention will be apparent from and elucidated with reference to the embodiments described hereinafter.

The present invention will now be described in more detail in relation to the enclosed drawings, in which:

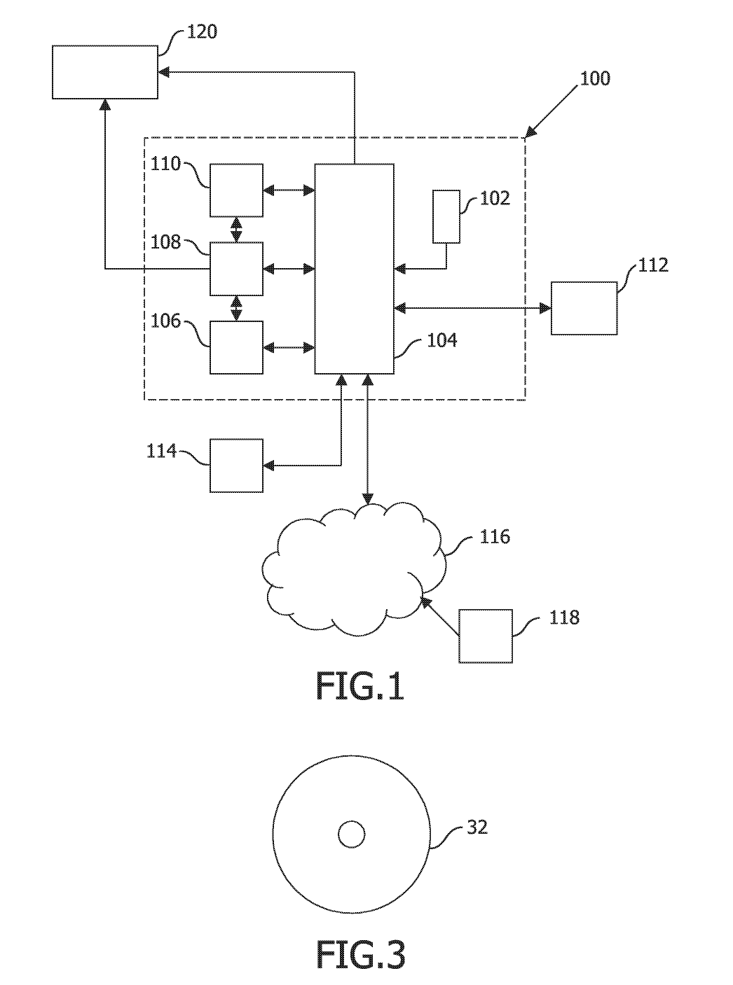

FIG. 1 shows a multimedia presentation system comprising a multimedia presentation generating device according to one embodiment of the present invention connected to external units,

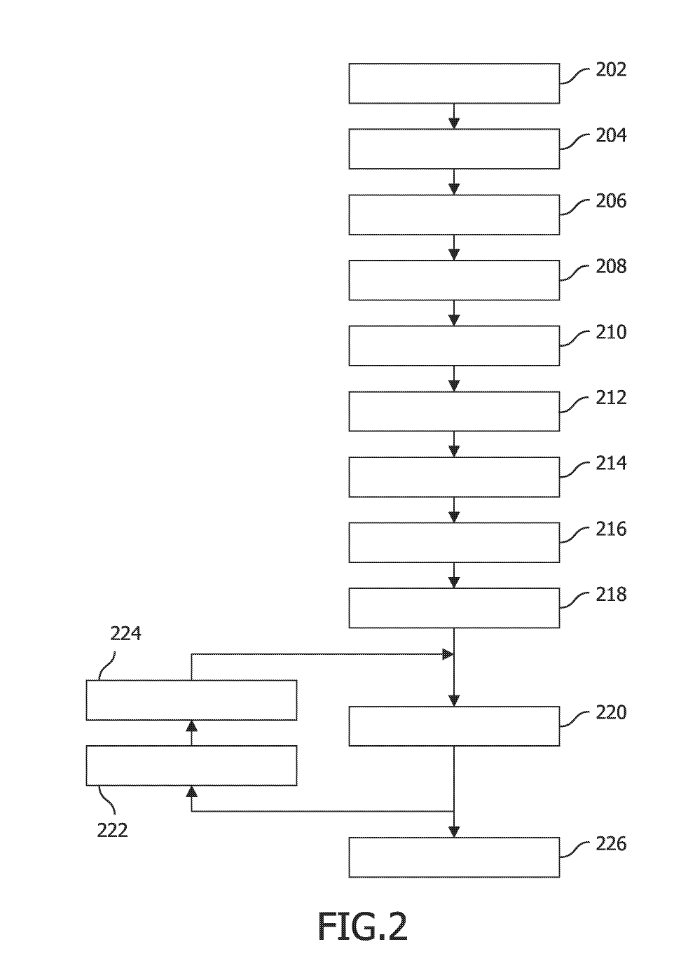

FIG. 2 presents a flow-chart of a method for generating a multimedia presentation according to one embodiment of the present invention, and

FIG. 3 presents a schematic view of a computer program product according to the present invention.

The present invention thus enables combining personal media content and additional media content for the purpose of generating a more appealing and engaging experience to the user when being presented the personal media content.

Photos, for instance, from a vacation may become boring to watch after some time. Showing one slide after the other, using a fixed mode of presentation, may have a tiring effect on an audience to which the slides are presented.

Manual editing of a slide show is cumbersome. Manual editing of a multimedia presentation is extremely cumbersome and takes enormous amounts of time if at all possible in practice for the average user.

Enriching a slide show or multimedia presentation is a huge task and requires various skills using the current technology.

The present invention relates to generating a multimedia presentation of personal media content, such as a set of photos, a video recording, an audio recording or any combination thereof, according to one embodiment of the present invention. Other types of media files, such as graphics files, text files, spreadsheets, etc., may also be visualised on which a presentation may be based, according to an alternative embodiment of the present invention. Since presenting the photos, the video recording or the audio recording as such, may be of limited interest to an audience after some time, possibilities to enrich a multimedia presentation, such as a slideshow have been looked in to.

One idea behind the present invention is to combine the set of photos, to mention one example, and media information available from a server, a photo album, a DVD, or via a network such as the Internet, having content similarities or content associated data similarities with the content as comprised in the set of photos.

By limiting the area in which a matching media file is to be looked for, the number of resulting matches drastically decreases. When specifying the Internet as the media file location an additional limitation is to be preferred, in order to avoid receiving too many matching media files.

Within the present invention content associated data such as meta data or annotation data may be used for detecting similarities between media files. Media file meta data may typically contain information on when and how a certain picture or video was acquired. Information on where the media file was acquired and by whom as well as who may be present on the picture may also be comprised in the meta data.

Another idea behind the present invention is using the meta data that is available from a first media file, in this case the set of photos, and optionally be using additional meta data added by the user, and look for media files having meta data that match the meta data of the set of photos which meta data optionally includes added meta data by the user.

For instance, if one picture was acquired in London, London is most likely to be available as meta data for that particular picture. Performing a meta data match would comprise searching for media files comprising London as meta data.

As mentioned above and as will be further exemplified below, the inclusion of one or more filtering criteria is one way to limit the number of matching hits so that a reasonable number of matches only are received.

It should be noted that the meta data is one type of content association data. This content associated data may alternatively or in combination comprise annotations that may be associated with a media file. The content associated data may also comprise property related data, such as colour composition data, texture data, shape related data, edge related data, motion data, and audio feature data, of which the colour composition of a photo is one example only. Such information may hence also be used in the search for matching media files.

One example of colour composition data is an image histogram showing the comprised colours and their respective overall intensities, which image histograms are well known a person having skills in the art. Shape related data may be data on the shape of objects that are present in for example a photo. Also the data on the presence of certain objects, for instances faces, may also be used.

In order to enhance the appearance of a slide show or multimedia presentation as presented to the user, a number of questions or user inquiries may be generated by the device based on the meta data of the photos and by other content associated data. The user will thus be presented a number of questions related to the photos as comprised in the slide show. The questions may alternatively relate to meta data from the matched media files. Questions that may frequently be asked comprise questions that relate to “who”, “what”, “when” and where”. For example who is in the photo, what are other important objects or buildings, what time, what approximate date and where was the photo taken. These questions or user inquiries are presented to the user during the presentation of the multimedia presentation. Upon receiving user input, that is the answers to the user inquiries, the multimedia presentation that is being presented is updated in real time in dependence of the answers as received by the device and as given by the user.

The multimedia presentation is thus interactive and when rendering the presentation the received user input, that is the answers to the user inquiries, is taken into account.

The multimedia presentation is therefore dependent on the answers as received by the device.

Apart from generating user inquiries that are forwarded to the user, additional media content as gained from the matching media files may be added to the presentation, that is the set of photos in this case. The photos may also be altered by way of using the matching media files, according to one alternative embodiment of the present invention. There are hence various possibilities for enhancing the appearance of the set of photos when presenting them to a user or a several users.

With reference to FIG. 1 showing a multimedia presentation generating system comprising a multimedia presentation generating device, according to one embodiment of the present invention, the present invention is explained in more detail.

According to one embodiment of the present invention, the multimedia presentation generating device 100 comprises a user input interface 102, such as a keypad, a set of buttons, a touch screen or the like. By operating this user input interface 102 the multimedia presentation generating device 100 may hence receive user input. According to one embodiment of the present invention, the multimedia presentation generating device 100 further comprises a control unit 104, a user inquiry generating unit 106, a multimedia presentation generating unit 108, and a matching unit 110. The multimedia presentation generating device 100 may also be connected to a multimedia presentation rendering unit 120, a first media location unit 112, a second media location unit 114, and a remote media location unit 118 via a network 116. It is obvious that the multimedia presentation generating device 100 may be connected to more units, but also to other units. The external units that are displayed in FIG. 1 is to visualise examples of external units that may be connected to the multimedia presentation generating device, according to the present invention.

Within the multimedia presentation generating device 100, the control unit 104 is connected to the user input unit 102, the user inquiry generating unit 106, the multimedia presentation generating unit 108 and the matching unit 110, according to one embodiment of the present invention. The multimedia presentation generating unit 108 is further connected to the user inquiry generating unit 106 and the matching unit 110.

The multimedia presentation rendering unit 120 is connected to the control unit 104 and to the multimedia presentation generating unit 108 of the multimedia presentation generating device 100. The external units and networks, such as the first media file location unit 112, the second media file location unit 114 as well as the network 116 are connected to the control unit 104 of the multimedia presentation generating device 100, according to one embodiment of the present invention.

Needless to say there are alternative ways and possibilities to connect the units within the multimedia presentation generating device 100 to each other and even to connect the external units to the internal units. Such ways and possibilities may be realised within an alternative embodiment of the present invention. Moreover, the multimedia presentation generating device 100 may further contain additional units such as a memory unit for enabling explicit storage of content associated data such as meta data or annotation data, or even other types of data.

By referring to FIG. 2, and Table 1, presenting a flow-chart of a method for generating a multimedia presentation and short task descriptions of the steps comprised within the method for generating a multimedia presentation, respectively, according to one embodiment of the present invention, the method for generating a multimedia presentation is explained in more detail.

According to one embodiment of the present invention, the method starts with the step of obtaining a user selection of a first media file, step 202. The set of photos is thus one example of a first media file only. The first media file may be a recording comprising both video and audio content, an audio file only or contain one or more paragraphs containing text or being a combination thereof. The first media file is simply a file on which a user of a multimedia presentation generating device 100 intends to at least partly base a multimedia presentation on. For this reason it is easy to imagine that the first media file may have various different properties and content.

TABLE 1
Short task descriptions of the steps comprised in the method for
generating a multimedia presentation according to one embodiment
of the present invention. With the step of obtaining a user
selection of a first media file the device obtains the user
selection via the user input interface 102 that may be a user
input unit such as a keyboard or the like as explained earlier.

| STEP | |
|---|---|
| NO. | SHORT TASK DESCRIPTIONS OF STEP NO. |
| 202 | Obtaining a user selection of a first media file |
| 204 | Obtaining content associated data of the first media file |
| 206 | Receiving content associated data from the user |
| 208 | Obtaining a user selection of a media file source |
| 210 | Obtaining at least one filtering criterion |
| 212 | Filtering out at least one second media file using the obtained |
| | filtering criterion |
| 214 | Matching content associated data of the first media file and content |
| | associated data as received from the user with content associated |
| | data of at least one second media file |
| 216 | Generating at least one user inquiry related to the matching content |
| | associated data |
| 218 | Creating a multimedia presentation, based on the first media file |
| | and the at least one second media file, including the at least |
| | one user inquiry |
| 220 | Presenting the multimedia presentation to the user |
| 222 | Receiving a user input related to the least one user inquiry |
| 224 | Updating the multimedia presentation being presented in |
| | dependence of the user input related to the at least one user |
| | inquiry |
| 226 | Ending the method for generating a multimedia presentation |

Having received the user selection of the set of photos, in this case, the subsequent step is the step of obtaining content association data of the first media file, step 204. In this case, obtaining meta data of the set of photos, is one example of obtaining content association data of the first media file. The device receives information about the set of photos by obtaining meta data of the set. Within this step the device may read meta data from received photos, or alternatively may read meta data from a location external to the multimedia presentation generating device 100 receiving the data, such as the first media file location unit 112.

According to one alternative embodiment of the present invention, the method for generating a multimedia presentation contains the step of obtaining annotation data, wherein the annotation data is another example of content association data, besides to the meta data as exemplified above.

According to one alternative embodiment of the present invention, the method for generating a multimedia presentation contains the step of obtaining property related data, being one type of content associated data. As mentioned above such property related data may comprise colour composition data, texture data, shape related data, edge related data, motion data, and audio feature data.

The next step of the method for generating a multimedia presentation according to one embodiment is the step of receiving content association data from the user, step 206. In this case the content association data is exemplified in meta data received from a user. Within this step the user of the multimedia presentation generating device inserts, types, forwards or the like input data such as meta data to the control unit 104 of the multimedia presentation generating device 100. This meta data that is received may be meta data related to the first media file, as in this case is the set of photos.

If for instance the amount of meta data is small, additional meta data on whom is shown on the photos, where from the people originated and where the people went after the photo was taken, to mention a few examples only, may be added by the user.

Also, additional information that the user may find worth mentioning in connection to presenting the photo or features that the user may want to combine with the photo in this case, but which features may not be present in the photo may be added. In the subsequent step down below it is explained how to find data containing such additional information.

Having received content associated data from the user, within step 206, the step of obtaining a user selection of a media file source, for example the Internet follows in step 208. Within this step the user is thus selecting wherefrom the multimedia presentation generating device 100 will be searching for the media file. The user may thus specify in which folders, via which network, in which photo albums or in which DVD's the media file is to be searched. Within this step of the method for generating a multimedia presentation the multimedia presentation generating device 100 receives user input from the user input interface 102.

Subsequent to obtaining a user selection on in which media file source the media file is to be searched, the step of obtaining at least one a filtering criterion, step 210, is next. It is within this step as the user may specify the type or category of media files to look for. For example the search or match may be restricted to cartoons, Disney films, favourite director's films, The Matrix films, animal films, etc. By setting one or more filtering criteria the number of media files that may match the meta data from the first media file or as added by the user, decrease. This may be found advantageous since the number of matches else may turn out to be too high.

Having defined the filtering criteria, the criteria are used within the step of filtering out at least one second media file using the obtained filtering criterion, step 212. This may be performed by applying the filtering criterion to the media files of the media file source. Only the media files that fulfil the filtering criterion can thus pass the criterion, thereby decreasing the number of files searched through in a subsequent step.

Now, having obtained content associated data of the first media file and optionally content associated data as received by the user, together with information on where to search for a media file, the step of matching content associated data of the first media file and meta data as received from the user with content associated data of at least one second media file from the media file source, step 214 is performed. In this case wherein the set of photos is the first media file, meta data from the set of photos and meta data as received from the user will be matched with meta data from at least one second media file from a media file source, as selected by the user and as received by the multimedia presentation generating device 100.

According to one alternative embodiment of the present invention annotation data may be used instead or in addition to the meta data, the annotation data is another example of content associated data of a media file, as mentioned above.

Alternatively media file property related data may be used instead or in addition to meta data and/or annotation data.

This step of matching content associated data is performed by the matching unit 110 of the multimedia presentation generating device 100 under the control of the control unit 104, where the control unit 104 is connected to the media file source as selected by the user in step 208, and from which the matching unit searches for media file having content association data that match the content associated data of the first media file or the content associated data as received from the user, in step 206.

According to another embodiment of the present invention the step of filtering out the at least one second media file using the obtained at least one filtering criterion, step 212, is comprised within the step of matching content associated data, step 214.

Subsequent to the step of matching, step 214, the step of generating at least one user inquiry related to the matching content associated data, step 216 is performed in the method for generating a multimedia presentation. Within this step the method automatically generates user inquiries such as questions or user inquiries which are forwarded to the user of the device for generating a multimedia presentation 100. The questions may thus be related to information as being present in the first media file, that is in this case the set of photos, as meta data or annotation data or may be related to other content associated data as added by the user in the step 206. The questions may however also be related to additional content associated data that are present in the at least one second media file, which content associated data was neither presenting the first media file nor as received by the user of the multimedia presentation generating device 100.

This step of generating at least one user inquiry is performed by the user inquiry generating unit 106 of the multimedia presentation generating device 100 under the control of the control unit 104. For this reason the user inquiry generating unit 106 is connected to the control unit 104. As the matching unit 110 is connected to the control unit 104, the user inquiry generating unit 106, also being connected to the control unit 104, can receive user inquiry information from the matching unit 110 in order to present the user inquiries to the user.

The next step of the method for generating a multimedia presentation, is the step of creating a multimedia presentation based on the first media file and the at least one second media file, including the at least one user inquiry, as generated in step 216, step 218. A multimedia presentation is thus created from the first media file, at least one second media file whose content association data matches the content association data of the first media file or possibly the additional information as received from the user. The multimedia presentation as created in this step comprises the at least one generated user inquiry.

Within the device for generating a multimedia presentation 100 the multimedia presentation generating unit 108 generates the multimedia presentation under the control of the control unit 104. As displayed in FIG. 1, schematically showing a multimedia presentation system including a multimedia presentation generating device 100, it is shown that the multimedia presentation generating unit 108 may be connected to the matching unit 110, the user inquiry generating unit 106 as well as to the control unit 104, according to one embodiment of the present invention.

The multimedia presentation generating unit 108 may thus have access to the information of the matching unit 110 and the user inquiry generating unit 106.

After having created the multimedia presentation in step 218, the step of presenting the multimedia presentation follows in step 220. The presentation may be presented to the user by utilising the multimedia presentation rendering unit 122.

According to one embodiment of the present invention, the multimedia presentation as presented by the multimedia presentation rendering unit 122, may be presented by using audio and video information.

According to an alternative embodiment the multimedia presentation is presented by using a dedicated media presentation rendering unit, which media presentation unit is designed to present audio information only. Such dedicated media presentation rendering unit may have the facility to transform certain video information to audio information, so as to enhance the appearance to a blind user. Also, according to another alternative embodiment the multimedia presentation may be presented by using a dedicated video presentation rendering unit to create a more appealing and engaging experience of the multimedia presentation to a deaf user. Such a device may similarly transform audio information to video data. Needless to say, the multimedia presentation may be presented to both blind users and deaf users as is.

If the multimedia presentation generating device 100 does not receive any user input as an answer to the user inquiries as presented to the user, the device recognizes this as if the user no longer is present and ends the method for generating a multimedia presentation, step 226.

Within this step the control unit 104 typically turns the device for generating a multimedia presentation 100 off, after which the multimedia presentation rendering unit 122, which may comprise a screen or a loudspeaker, or a combination therefore, is turned off. According to an alternative embodiment of the present invention, the multimedia presentation generating device proceeds presenting the presentation based on at least the first media file, although no input has been received from the user for a certain amount of time, such as for example for a few tens of seconds. The multimedia presentation device advances the presentation to a subsequent item within the presentation being presented.

If, however, the control unit 104 receives user input via the user input interface 112 after having started the presenting the multimedia presentation in the step 220, within the step of receiving user input related to the at least one user inquiry, the multimedia presentation is not terminated at this stage. Rather, after having received a user answer to the at least one user inquiry, the step of updating the multimedia presentation being presented in dependence of the received user input related to the at least one user inquiry, step 224, is performed.

Within this step of updating the multimedia presentation the presentation is updated in real time according to one embodiment of the present invention. By updating the presentation in real time as in dependence on an answer out of a large number of possible or thinkable correct or erroneous answers, an interactive non-linear multimedia presentation is provided to the user.

Immediately after having received user input in the step of 224 the multimedia presentation is presented to the user via the multimedia presentation rendering unit 122, such that the user can enjoy the updated presentation.

If the device for generating a multimedia presentation 100 receives more user input as answers to user inquiries, within the step of 222, receiving user input related to at least one user inquiry, the step of updating the multimedia presentation is performed, step 224. Having again updated the multimedia presentation the updated presentation is presented to the user by using the multimedia presentation rendering unit 122.

The presentation rendering unit 122 continues to present the multimedia presentation in this way as long as there is available information from the first media file or alternatively from the at least one second media file. This information may comprise the pertinent content associated data.

If, however, no user input as answer to the at least one user inquiry is received by the device for generating a multimedia presentation device 100 is received, the method for generating the multimedia presentation is ended by the control unit 104, in the step of 226. FIG. 3 presents a computer program product 32 according to a one embodiment of the present invention. This computer program product comprises a computer readable medium for making a computer or a multimedia presentation generating device execute, when said computer program product is loaded in the computer or in the multimedia presentation generating device, obtaining a user selection of a first media file, obtaining a user selection of a media file source, matching content associated data of the first media file with the user content associated data of at least one second media file from the media file source, generating of at least one user inquiry related to the content associated data of at least the first media file, and creating of the multimedia presentation, based on the first media file and the at least one second media file, said multimedia presentation comprising the at least one generated user inquiry, such that a user may receive a more appealing and engaging experience when being presented the multimedia presentation.

The computer program product may be provided as a CD-ROM disc according to one embodiment of the present invention. However, the computer program product can alternatively be provided on another type of disc such as a DVD disc, a hard disc, an MD disc, or be provided in a memory or in another storage medium or download from a network.

The invention can be varied in many more ways, for instance:

The method for generating a multimedia presentation may comprise a step of receiving user input as to whether media content available in the first file is to be altered or added by novel matched content, according to an alternative embodiment of the present invention.

According to yet an alternative embodiment of the present invention, the method for generating a multimedia presentation comprises a step of receiving a user selection of multimedia presentation properties, such as the style of the presentation, a theme, an occasion, to mention a few examples of presentation properties.

According to an alternative embodiment of the present invention several users located at various places may be connected to one or more device for generating a multimedia presentation 100, as users.

According to yet an alternative embodiment of the present invention, the user input interface may comprise a multiple of user input units connected to the multimedia presentation generating device, by upon using the multiple user input units several users may be presented the multimedia presentation.

According to another embodiment of the present invention, at least one user input unit and one information presentation unit may be connected to the multimedia presentation generating device via a network, such as the Internet.

According to yet another embodiment of the present invention, at least two multimedia presentation generating devices 100 may be connected to each other, either directly or via a network, such as the Internet. A user of a first device may have the privilege to give user input to a second device, which device thus may be connected to the first device via a network, such that the user may affect a multimedia presentation being generated by the second multimedia presentation generating device. Similarly, a user of the second device may affect a multimedia presentation being created by the first device for generating a multimedia presentation.

According to yet another embodiment of the present invention, the multimedia presentation can be used for learning purposes, for all ages since the design of the method and the device allows the user to set the content associated data to be used for the generating of the multimedia presentation including the generated user inquiries.

The device according to the present invention would function well for e-learning purposes when for instance being connected to, and possible controlled by, a second device for generating a multimedia presentation possibly over a network such as the Internet. The device for generating a multimedia presentation may also be designed to become a math interactive presentation, forwarding user inquiries such as “Count how many people are in the picture?”, “How many yellow shirts?”, etc. This type of questions can be set up ahead of time by using multimedia content analysis technology, which is well known to the skilled person in the art. Face detection can be used for the question: “How many people are in this picture?” Within a different type of interactive multimedia presentation questions such as “How many X?” for children where X may be determined by the usage of an object detection algorithm. Object detection algorithms have the ability to detect buildings, balls, cars and objects with well defined shapes. Also, the name of the people in the pictures may be assigned by using on-line face recognition and technology, comprising on-line ace recognition algorithm, and associating the faces with names, by for instance only giving a few examples of a particular person. Such face recognition technology is well known to the skilled person in the art. An interactive presentation like “similar-to” is also possible to set up automatically where face models found in consumer photos are compared to face models of celebrities. Any face recognition technology can be used for this purpose. Needless to say, such face recognition technology is well known to the skilled person in the art and is not described any further here.

According to various alternative embodiments of the present invention the device may be used for other and more types of gaming, such as matching left and right side of faces of persons, by forwarding user inquiries related to the different sides of faces. An alternative embodiment of this kind could be “I spy . . . ” interactive presentation for children, in which a child is asked to spy an object that may be visually hidden or hard to detect to an un-trained eye. Here superimposing graphics, text or parts of photos may be used. In these “I spy . . . ” interactive presentations an algorithm may embed graphics and objects in the areas where the image has high texture regions. The high texture regions can be computed using a texture segmentation algorithm or alternatively a texture computation algorithm.

For games for adult people, the device for generating a multimedia presentation may be used, according to one alternative embodiment, for which one or more users are to answer questions related to film sequences, video clips or the like. Many more possible alternatives are also conceivable.

According to yet an alternative embodiment of the present invention a game such as “guess next” may be used, in which the user is asked to guess the next content item, such as a photo for instance. The order of the content item in the presentation can then be determined by the multimedia presentation generating device based on the content associated data, for example the meta data. Photos may hence be sorted by who is in the photo or where or when the photo was taken. The goal for the user is to guess the actual order of the photos, in this application.

It shall be paid attention to that:

“Comprising” or “comprises” does not exclude other elements, steps, units, etc.

“A” or “an” does not exclude a plurality of the respective items.

A single unit may fulfill the functions of several units recited in the claims.

The reference signs (still to be included) in the claims shall not be construed as limiting the scope.

The method for generating a multimedia presentation, the multimedia presentation generating device and the computer program product according to the present invention, have the following general advantage:

The present invention has the advantage that it enables the user to interactively create a multimedia presentation, such that the user may receive a more appealing and engaging experience when being presented the multimedia presentation.

In summary, the invention relates to the following:

The present invention enables combining personal media content and additional content with the purpose of generating a more appealing and engaging experience to the user when being presented the personal media content. The invention therefore relates to a method and a device for generating a multimedia presentation, comprising obtaining a user selection of a first media file (step 202), obtaining a user selection of a media file source (step 208), matching content associated data of the first media file, with content associated data of at least one second media file from the media file source (step 214), generating at least one user inquiry related to the content associated data of at least the first media file (step 216), and creating the multimedia presentation, based on the first media file and the at least one second media file, said multimedia presentation comprising the at least one generated user inquiry (step 218).

1. A method for generating a multimedia presentation, comprising the steps:
obtaining a user selection of a first media file (step 202),
obtaining a user selection of a media file source (step 208),
matching content associated data of the first media file, with content-associated data of at least one second media file from the media file source (step 214),
generating at least one user inquiry related to the content associated data of at least the first media file (step 216), and
creating the multimedia presentation, based on the first media file and the at least one second media file, said multimedia presentation comprising the at least one generated user inquiry (step 218),
such that a user may receive a more appealing and engaging experience when being presented the multimedia presentation.

2. The method for generating a multimedia presentation according to claim 1, further comprising the step:
presenting the multimedia presentation including the at least one generated user inquiry to a user (step 220), wherein presenting the multimedia presentation comprises the steps of receiving user input related to the at least one user inquiry (step 222), and updating the multimedia presentation being presented in dependence of the received user input related to the at least one user inquiry (step 224).

3. The method for generating a multimedia presentation according to claim 1, further comprising the step:
obtaining content associated data of the first media file (step 204).

4. The method for generating a multimedia presentation according to claim 3, wherein the step of obtaining content associated data of the first media file comprises obtaining media file property related data.

5. The method for generating a multimedia presentation according to claim 1, further comprising the step:
obtaining at least one filtering criterion (step 210), and
in which the step of matching content associated data (step 214) further comprises the step of filtering out the at least one second media file using the obtained at least one filtering criterion (step 212).

6. The method for generating a multimedia presentation according to claim 1, further comprising the step:
receiving content associated data from the user (step 206).

7. The method for generating a multimedia presentation according to claim 6, in which the step of matching content associated data (step 214) comprises matching content associated data of the first media file and the content associated data as received from the user, with content associated data of the at least one second media file from the media file source.

8. The method for generating a multimedia presentation according to claim 6, in which the in which the step of generating at least one user inquiry (step 216) further comprises generating at least one user inquiry related to content associated data as received from the user.

9. The method for generating a multimedia presentation according to claim 6, wherein receiving content associated data from the user comprises receiving meta data.

10. The method for generating a multimedia presentation according to claim 6, wherein receiving content associated data from the user comprises receiving annotation data.

11. A multimedia presentation generating device (100), for generating a multimedia presentation, said device comprising:
a user input interface (102), arranged to obtain input from a user,
a matching unit (110), arranged to match content associated data of a first media file with content associated data of at least one second media file,
a user inquiry generating unit (106), arranged to generate at least one user inquiry related to content associated data of a media file,
a multimedia presentation creating unit (108), connected to the matching unit (110) and the user inquiry generating unit (106), wherein the multimedia presentation creating unit (108) is arranged to create a multimedia presentation based on the first media file, the at least one second media file, and the content associated data of at least the first media file,
a control unit (104), connected to the user input interface (102), the matching unit (110), the multimedia presentation creating unit (108), and the user inquiry generating unit (106),
which control unit (104) is arranged to control the steps of obtaining a user selection of a first media file (step 202), obtaining a user selection of a media file source (step 208), matching content associated data of the first media file with content associated data of at least one second media file from the media file source (step 214), generating at least one user inquiry related to the content associated data of at least the first media file (step 216), and creating the multimedia presentation, based on the first media file and the at least one second media file, said multimedia presentation comprising the at least one generated user inquiry (step 218),
such that a user may receive a more appealing and engaging experience when being presented the multimedia presentation.

12. A multimedia presentation generating device (100) according to claim 11, connectable to a multimedia presentation unit (122).

13. A multimedia presentation generating device (100) according to claim 11, connectable to at least one media file location unit (112,114,118).

14. A computer program product (32) comprising a computer readable medium, having thereon computer program code means, to make a multimedia presentation generating device (100) or a computer execute, when said computer program code means is loaded in the multimedia presentation generating device (100) or the computer:
obtaining a user selection of a first media file (step 202),
obtaining a user selection of a media file source (step 208),
matching content associated data of the first media file with content associated data of at least one second media file from the media file source (step 214),
generating of at least one user inquiry related to the content associated data of at least the first media file (step 216), and
creating of the multimedia presentation, based on the first media file and the at least one second media file, said multimedia presentation comprising the at least one generated user inquiry (step 218),
such that a user may receive a more appealing and engaging experience when being presented the multimedia presentation.

15. A computer program element comprising computer program code means, to make a multimedia presentation generating device (100) or a computer execute, when said computer program code means is loaded in the multimedia presentation generating device (100) or the computer:
obtaining a user selection of a first media file (step 202),
obtaining a user selection of a media file source (step 208),
matching content associated data of the first media file with content associated data of at least one second media file from the media file source (step 214),
generating of at least one user inquiry related to the content associated data of at least the first media file (step 216), and
creating of the multimedia presentation, based on the first media file and the at least one second media file, said multimedia presentation comprising the at least one generated user inquiry (step 218),
such that a user may receive a more appealing and engaging experience when being presented the multimedia presentation.
